(19) United States
(12) Patent Application Publication
(10) Pub. No.: US 2023/0066143 A1
(43) Pub. Date: Mar. 2, 2023

(54) GENERATING SIMILARITY SCORES BETWEEN DIFFERENT DOCUMENT SCHEMAS

(71) Applicant: Oracle International Corporation, Redwood Shores, CA (US)

(72) Inventors: Liviu Sebastian Matei, Bucharest (RO); Filip Trojan, Beroun (CZ); Marc Michiel Bron, London (GB); Andrew Kenneth Hind, Reading (GB); Yingzhao Zhou, Hook (GB); Maria-Monica Petrica, Bucharest (RO); Rajesh Ashwinbhai Shah, San Jose, CA (US)

(73) Assignee: Oracle International Corporation, Redwood Shores, CA (US)

(21) Appl. No.: 17/464,534

(22) Filed: Sep. 1, 2021

(51) Int. Cl. G06F 16/31; G06F 16/35; G06K 9/62

(52) U.S. Cl. CPC G06F 16/319; G06F 16/35; G06K 9/6215

(57) ABSTRACT

A document may be received as part of a request to identify similar documents in a collection of documents. However, the received document and the documents in the collection may have different schemas or formats. To provide semantic context to the search and allow similarity scores to be generated between different document types, a configuration may be accessed that defines how to generate queries from one schema into another schema. The configuration may map queries between different fields in both schemas. Results of the multiple queries can be combined to generate a weighted combination for each document that can be used as a similarity score between different document types.

### BACKGROUND

Document repositories may include a large number of documents in a persistent storage system. These documents may include structured and unstructured data, and may conform to many different schema types. For example, a document repository representing a knowledge base may include FAQs, white papers, webpages, emails, and/or other information that may be used to address various problems in an operating environment. While the document repository may store a great deal of information, it is also very difficult to search this information effectively, as the document repository may include many different document types that are difficult to uniformly analyze.

An existing method of identifying documents that may be relevant to a source document is to generate a similarity score. A similarity score is a metric calculated by a search interface of the repository that represents a measure of how syntactically similar two documents may be. A source document may be compared to each of the individual documents in the document repository to generate a similarity score for each document in the repository. These scores can then be used to identify documents that are most likely to be similar to the source document.

### BRIEF SUMMARY

The embodiments described herein allow a document repository made up of documents having many different schemas to be searched and compared to an input document to generate a similarity score. The similarity score can be used to identify documents in the document repository that are most similar to the input document. The schema of the input document can be identified and used to retrieve a configuration specific to that schema. The configuration may include information that defines how queries can be automatically generated and submitted to the document repository such that a search can be performed between different fields in documents with different schemas. These queries can be concatenated and submitted to the document repository. The weighted scores generated for the result documents can be aggregated together to generate a final similarity score for each document.

Instead of merely searching documents for syntactic similarity, the configuration allows the queries submitted to the document repository to be more likely to generate semantic similarities, such that the meanings or concepts expressed in the documents are more likely to be similar. The configurations can be tailored to specifically map high-frequency n-grams in specific source fields to specific target fields in documents having specified schemas in the document repository.

The document repository may be designed to include an interface that allows for document indexing. An existing document repository may be crawled and/or documents may be submitted that are indexed into an inverted index. The data cleanup process may remove extraneous information or metadata that is not related to the semantic meaning of the documents before indexing takes place. The system may also include a search interface for the inverted index as well as a document frequency API that can be used to retrieve a document frequency for specific words. This document frequency may be used to generate a frequency score for individual words. This frequency score may be used to select which words in the target field are used for generating search queries.

The configuration itself may include separate sections for each schema that may be used as a source for the search queries. Search fields from the target document can be used to provide individual n-grams or other field values from the source field to generate a specified number of queries that can be concatenated together to form a single query. The resulting similarity scores may be weighted according to a value stored in the configuration. The various mappings between source fields and target fields—and between different schemas in the knowledge repository—may be aggregated together to form a final similarity score for each document. These similarity scores may then be used to order or present the results to the requesting user or device.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a system for submitting a document to a document repository to generate similarity scores, according to some embodiments.

FIG. 2 illustrates collections of documents having different schemas, according to some embodiments.

FIG. 3 illustrates a system for the document repository that may be used when generating queries for the similarity score process, according to some embodiments.

FIG. 4 illustrates a diagram of a similarity scoring system, according to some embodiments.

FIGS. 5A-5B illustrates an example of a configuration for a particular schema, according to some embodiments.

FIG. 6 illustrates a flowchart of a method for calculating similarity scores for documents, according to some embodiments.

FIG. 7 illustrates a simplified block diagram of a distributed system for implementing some of the embodiments.

FIG. 8 illustrates a simplified block diagram of components of a system environment by which services provided by the components of an embodiment system may be offered as cloud services.

FIG. 9 illustrates an exemplary computer system, in which various embodiments may be implemented.

### DETAILED DESCRIPTION

The embodiments described herein allow a document repository comprised of documents having many different schemas to be searched and compared to an input document to generate a similarity score. The similarity score can be used to identify documents in the document repository that are most similar to the input document. The schema of the input document can be identified and used to retrieve a configuration specific to that schema. The configuration may include information that defines how queries can be automatically generated and submitted to the document repository such that a search can be performed between different fields in documents with different schemas. These queries can be concatenated and submitted to the document repository. The weighted scores generated for the result documents can be aggregated together to generate a final similarity score for each document.

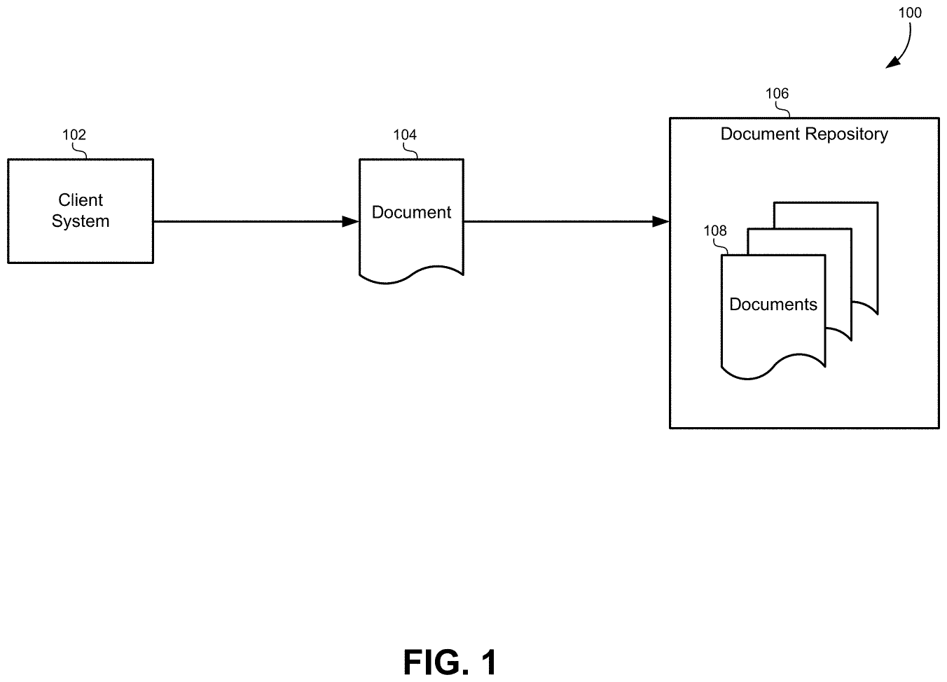

FIG. 1 illustrates a system 100 for submitting a document 104 to a document repository 106 to generate similarity scores, according to some embodiments. A client system 102 may submit a document 104 to a server, a web-based system, or cloud-based system which may be referred to generically as a “server” or “server system.” The document 104 may represent any type of document, including structured and/or unstructured data. By way of example, the document 104 may represent an incident report or trouble ticket received by an incident-management system. The document 104 may be generated by the client system 102.

Alternatively, the document 104 may be generated by the server that manages the document repository 106 and/or operates the incident management system in response to information submitted by the client system 102. For example, the client system 102 may submit information from a web form that is used to populate fields in the document 104 to generate an incident report either by the client system 102 or by the incident management system.

The document 104 may be received by the server system in order to find a document in the document repository 106 that is responsive to the information in the document 104. Continuing with the example of the incident-management system, the document 104 may represent a description of a problem or other incident relating to a service provided by a service provider. The document repository 106 may include documents 108 such as white papers, solutions to common problems, knowledge-base articles, and other information that may be responsive to the problem described in the document 104 and/or other problems that have previously been handled by the system. The similarity score represents a metric that indicates how closely the information in the document 104 is related to information in each of the documents 108 in the document repository 106. The higher the similarity score, the more likely one of the particular documents 108 provides information related to the topic of the document 104.

In a system such as this, similarity scores calculated by existing systems may simply execute comparison algorithms between the document 104 and the documents 108 in the document repository 106 to compare individual words. This can be very effective for finding a document in the document repository 106 that is syntactically similar to the document 104. However, a technical problem exists in that existing methods do not find a document in the document repository 106 that is semantically similar to the meaning expressed by the document 104. For example, existing techniques may identify documents 108 that use similar terminology as the document 104, but which are not related to a specific problem that is expressed in the semantics of the document 104. Another technical problem exists in that existing techniques do not intelligently map language from specific fields in the document 104 to other specific fields in the documents 108. Because semantic ideas may be expressed differently in different fields, and because matching ideas both particular source and target fields should be weighted more heavily than others, existing techniques often miss key connections between the ideas expressed in the document 104 and the documents 108.

The embodiments described herein solve these and other technical problems by using defined configurations that instruct the system how to generate intelligent queries that are able to link the meaning of the information expressed in the source of document 104 to the meanings in the identified documents 108 in the document repository 106 that are more likely to solve a problem expressed by the document 104. Additionally, these embodiments solve the technical problem of generating accurate comparisons and similarity scores between documents having different schemas. In structured documents, comparisons between all fields in the various documents may be inefficient and cumbersome. These embodiments provide targeted queries between specific fields between different schemas. Because information may be stored in different fields in different documents, the configurations define target fields and corresponding source fields where the information comparison will be most effective.

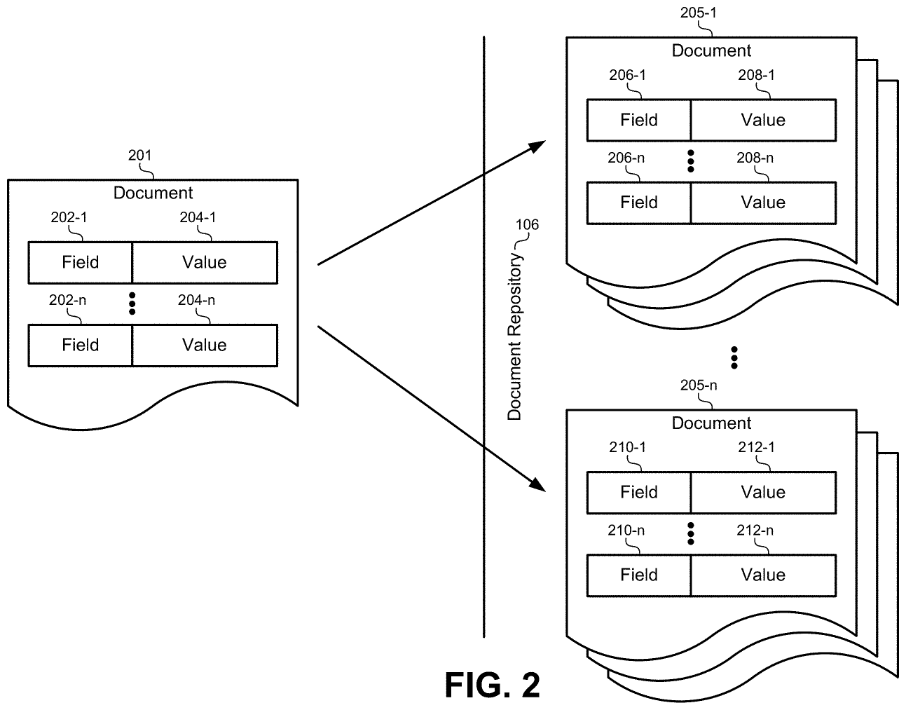

FIG. 2 illustrates collections of documents having different schemas, according to some embodiments. A document 201 received by the document repository 106 may have a first schema. As defined herein, a “schema” may refer to a structure of the document 200. For example, a schema may define a number of field-value pairs to be found in the document 201. Each of the fields 202 may be associated with corresponding values 204 that may be specific to each document instance. The fields 202 may define data types for the values 204. For example, a first field 202-1 may include a label, such as a “user name,” and may define a type as a “text string” such that the corresponding first value 204-1 may include a text string with a specific value for the user name. The first schema of the document 201 may define all of the field-value pairs, while individual documents using the schema may define specific values for the corresponding field-value pairs. The schema may also define other structural elements of the document, including styles, images, backgrounds, divisions, static text, and other document elements.

As used herein, the terms “first” and “second” are used merely to distinguish between various elements, such as different schemas. These terms do not imply order, precedence, importance, or any other characteristic of these elements, but instead serve only to distinguish one element from another element. For example, a first schema and a second schema may refer to two documents having individual schemas. The first scheme and the second schema may be the same or different schemas, such that both documents have the same schema or have different schemas.

Difficulties have traditionally arisen when the document 201 is submitted to the document repository 106. The document repository 106 may include a plurality of collections of documents 205. Each of the collections of documents 205 may be associated with individual schemas. For example, collection 205-1 may be associated with a first schema, and each document in collection 205-1 may share the same first schema. Other collections 205-n may each include different schemas. In traditional systems, the document 201 could only be compared to other documents in the document repository 106 that share the same schema. This allowed the similarity comparisons to be made between corresponding values in the field-value pairs. However, this greatly reduced the number of documents in the document repository 106 that could be accurately responsive to a request to generate a similarity score for the document 201. The embodiments described herein are able to generate similarity scores that match semantically between the document 201 having a first schema and any collection of documents in the document repository 106 having a second schema.

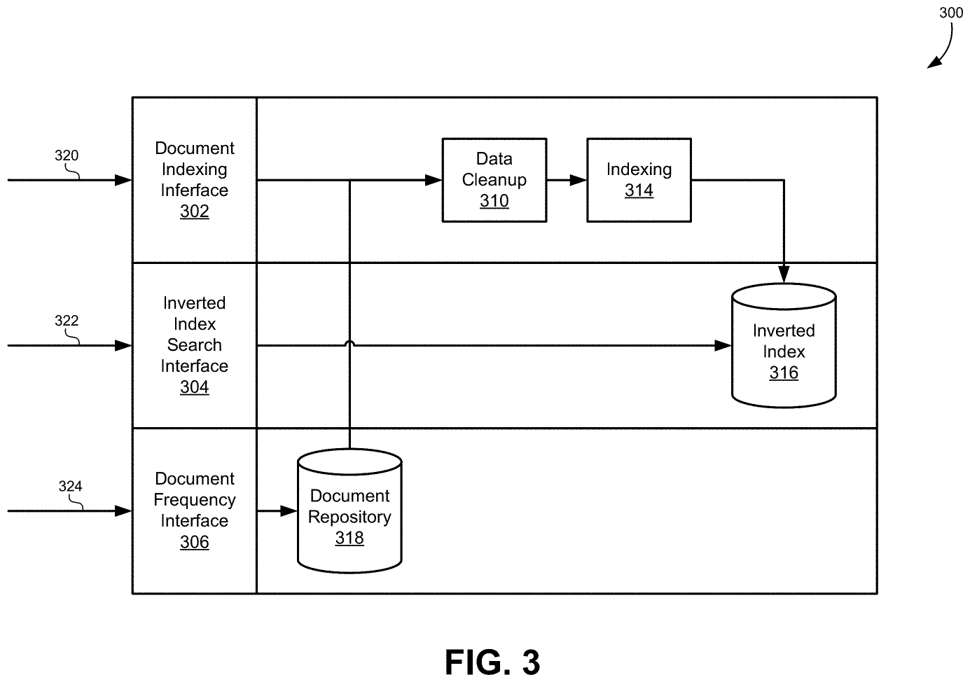

FIG. 3 illustrates a system 300 for the document repository that may be used when generating queries for the similarity score process, according to some embodiments. The system 300 may first include a document indexing interface 302. The document indexing interface 302 may receive a request 320 to index a new document being added to the document repository. Additionally, the document indexing interface 302 may access existing documents in an existing document repository 318 to crawl and index the documents in the document repository 318. A data cleanup process 310 may be used to remove information from the document that is not related to the semantic meaning of the document before the indexing process takes place. For example, the data cleanup process 310 may perform various data cleanup steps, such as the removal of JavaScript, HTML, code, CSS code, and other code or elements related to the display of the document, the structure or format of the document, or other metadata. After the data cleanup process 310, the document may be provided to an indexing process 314 that generates a reverse index or inverted index 316 for the document repository 318.

The inverted index 316 stores a list of each document in the document repository 318 that includes a particular word. An inverted index may include a database index storing a mapping from content, such as individual words, to its locations in a set of documents (in contrast to a forward index, which maps from documents to content). The purpose of an inverted index is to allow fast full-text searches, at a cost of increased processing when a document is added to the document repository 318. The system may also include an inverted index search interface 304 allows the system 300 to receive a request 322 querying the inverted index 316. The request 322 may include a word found in one or more documents in the document repository 318. The inverted index 316 may access the listing for the particular word and return a list of documents that include that word. The embodiments described herein may also allow the request 322 to specify a specific field in each document. For example, the request 322 may include a word to be searched in an SUBJECT field in a particular document schema. The inverted index 316 may be generated such that it is associated with a specific collection of documents all having same schema. Alternatively, the inverted index 316 may be generated such that collections of documents having individual schemas can be searched and indexed as collections separate from each other. The inverted index 316 may be searched using queries that include Boolean queries, phrase queries, word queries, single-value queries, and/or any other type of query.

The system 300 may also include a document frequency interface 306. This interface may be implemented using an Application Programming Interface (API) that retrieves a document frequency. The document frequency interface 306 or API may search the document repository 318 for a given word to retrieve the number of documents in which that word can be found. In some embodiments, the document frequency may be used to generate a document frequency score for a particular word. This score may be generated as (1) a measure of how often the particular word is found in the source document, multiplied by (2) an inverse measure of how many documents in the particular document collection include the word. The frequency score for a particular word may be used to generate queries as described in detail below.

In some embodiments, a system 300 with each of the interfaces described above may be implemented using the Apache® SOLR software, or may be built on top of the Apache® Lucene search system. However, these particular software solutions are provided only by way of an enabling example and are not meant to be limiting. Many other software systems may be used for which similar features may be implemented as described herein.

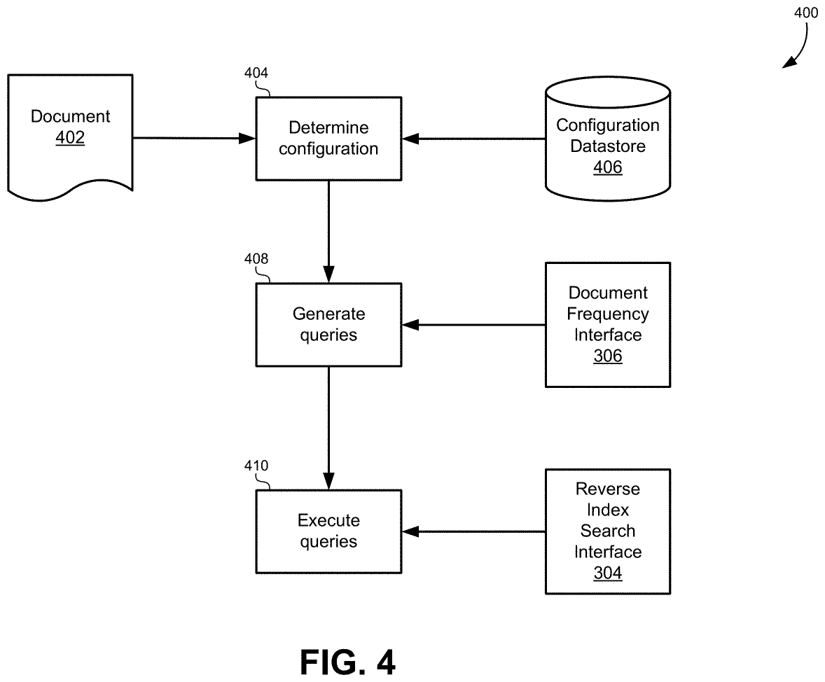

FIG. 4 illustrates a diagram of a similarity scoring system 400, according to some embodiments. The process executed by the similarity scoring system 400 may assume that a document repository has been properly indexed and processed as described above in relation to FIG. 3. Thus, the similarity scoring system 400 may submit requests to the various interfaces described above to receive document frequencies and perform searches of the inverted index.

A document 402 may be submitted to the similarity scoring system 400. The document 402 may be received from a client device and may represent any type of document, such as an incident report as described above in the example of FIG. 1. The similarity scoring system 400 may determine a specific configuration associated with a document 402 (404). For example, a configuration data store 406 may store configurations associated with each type of schema that may be received by the system or that may be stored in the document repository. The schema of the particular document 402 may be determined by examining the metadata or by identifying and matching the field-value pairs in the document 402 to a known schema. When the schema is identified, the schema may be submitted to the configuration data store 406 to retrieve a configuration that is specific to that schema. Thus, the configuration data store 406 may store configurations for each schema defined in the similarity scoring system 400.

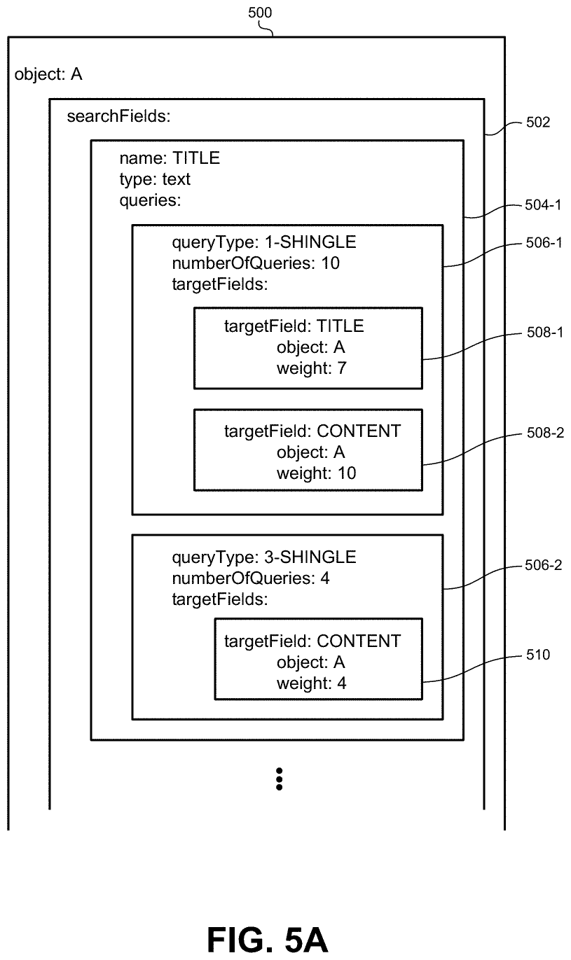

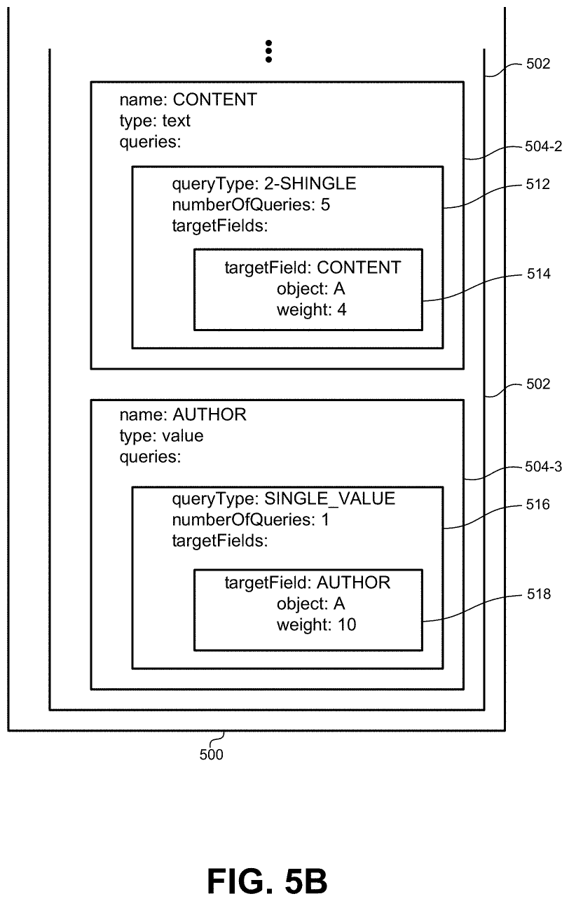

The similarity scoring system 400 may then generate a plurality of queries based on the configuration (408). A specific example of a configuration and how the configuration may be used to generate a plurality of queries is described below in relation to FIGS. 5A-5B. Generally, a configuration may include a set of fields that can be used as instructions for generating the queries from the source schema of the document 402. The queries may target any of the schema types stored in the document repository. For example, if the document 402 has schema A, the configuration may include fields that act as instructions for generating a set of queries between a document having schema A and a document having schema A, between the document having schema A and a document having schema B, and so forth. Thus, a configuration may include instructions that map queries from the schema of the source document 402 to a plurality of other schemas that may be present in the document repository.

Generating the queries may include receiving a document frequency score from the document frequency interface 306 described above. The document frequency score may be used to generate queries that are most likely to generate responsive answers. For example, the document frequency score may be used to generate queries for words in the source document 402 that are most likely to be found in the document repository. A plurality of queries may be generated for each field-to-field combination between the source document 402 and fields in the particular schema indicated by the configuration.

The similarity scoring system 400 may then execute the queries (410). These queries may be submitted together as a union (e.g., “OR”) set of queries that are submitted to the reverse index search interface 304. For example, some embodiments may create a master query that combines all of the queries together. This query may be executed, and the returned documents may receive a score. As described below, the configuration may include a weight that is applied to each score. The score returned by the search may apply the weight to the score from the index. For example, some search interfaces may receive a weight that boosts the return score as a multiplier. These scores can then be aggregated together for each document to generate a final similarity score for each document. Note that some embodiments need not normalize the scores, but instead the weighted scores may be used to compare documents to each other, which need not require normalization. The scores may then be displayed and/or used to order results for documents that are presented to the requesting client system or a user interface.

FIGS. 5A-5B illustrates an example of a configuration 500 for a particular schema, according to some embodiments. In this example, the configuration 500 has been selected for source document having schema A. The schema itself may be an object that has an object type that can be used to identify the configuration 500 from a plurality of different configurations associated with different source document schemas. The configuration 500 may be part of a larger configuration file that defines many different configurations for different schemas. The configuration 500 may be stored as a structured document, such as XML.

The configuration 500 may be used to generate a plurality of search fields 502 that can be executed as queries on the document repository. The search fields 502 may use the source fields 504 in schema A as sources for queries. In this example, a first source field 504-1 may identify the TITLE field of the source document and use words in the TITLE field to search different fields in a specified schema type in the document repository. The TITLE field may have a type of “text” indicating that it stores a text string. Each of the queries generated for the first source field 504-1 may use words from the first source field 504-1 as a source when building the queries. For each schema, one or more of the source fields 504 in the schema may be identified by the configuration and used to generate queries. For example, in addition to the TITLE field, a second search field 504-2 may identify the CONTENT field, and a third source field 504-3 may identify the AUTHOR field as sources for schema A.

In a source field, the configuration 500 may identify different query types 506. Each of the query types 506 may identify a number of words to be used for each query. For example, a first query type 506-1 may identify the type as 1-SHINGLE to instruct queries that match n-grams of order “1” (i.e., 1-grams) from the source filed to the different target fields in the target schemas. A second query type 506-2 may identify the type as a 3-SHINGLE to search on 3-grams from the source TITLE field in schema A. Another query type 516 may identify a type as a SINGLE VALUE type indicating that a single value from the source should be matched to the single value in the target field. For example, the name of an author may be required to match exactly between source and target fields.

The query types 506 may also identify a number of queries to be generated. For example, the second query type 506-2 may identify four queries to be generated as 3-grams from the source TITLE field of schema A. To determine which of the 3-grams from the TITLE field to use, the system may query the document frequency interface described above to retrieve a document frequency for each word in each of the 3-grams in the TITLE field. Queries may then be generated using the 3-grams that generate the highest document frequency score is a combination of the individual frequency scores of the individual words. As described above, the document frequency score may be a product of how often the words of the particular 3-gram appear in the source (TITLE) field and an inverse of how many documents in the document repository contain the words of the 3-gram.

Finally, each of the query types may identify one or more queries 508, 510, 514, 518 that may be generated for each query type. For example, a first query 508-1 may be comprised of 10 individual queries according to the first query type 506-1. Each of the individual queries may correspond to 1-grams (e.g., individual words in the TITLE field) with the highest document frequency score. The queries may target specific fields in specific schemas in the document repository. For example, the first query 508-1 may generate 10 queries that each search a different word in the TITLE field of documents in the document repository having schema A. Note that the example schema in FIGS. 5A-5B search fields from schema A against fields from other documents having the same schema A the document repository. However, this is provided only by way of example and is not meant to be limiting. The configuration 500 may also include other queries that target objects having different schemas (e.g. schema B) that are not specifically illustrated in these figures.

To generate the query 508-1, the 10 single words with the highest frequency score may be combined with an “OR” operator to form a single query that searches the TITLE field in schema A for any of those single words. The resulting scores generated by this query for each document can be multiplied by the weight (e.g., 7). This weighting allows the configuration to specify matches between fields that more strongly indicate a similarity in semantic meaning. Finally, each of the one or more queries 508, 510, 514, 518 may be concatenated, combined, and/or submitted to the index to generate weighted similarity scores. In some embodiments, the weight may be set by a user, or may be set automatically by a machine-learning model.

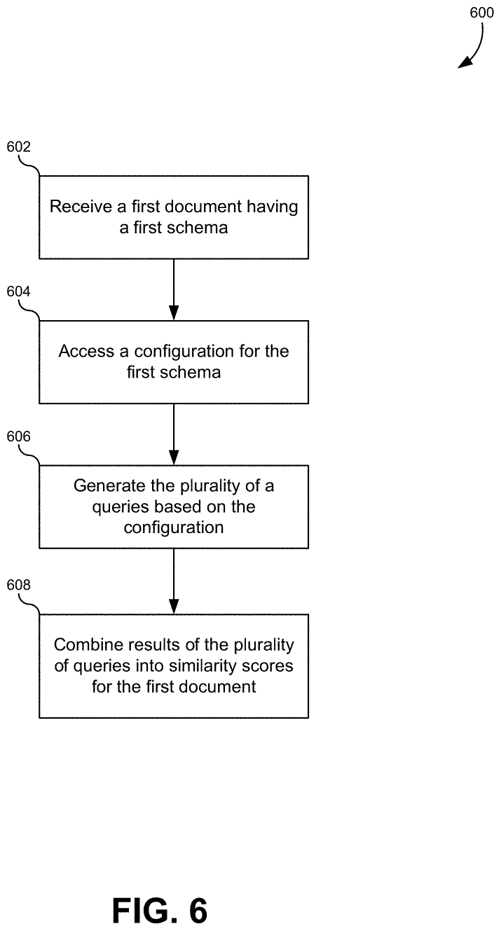

FIG. 6 illustrates a flowchart 600 of a method for calculating similarity scores for documents, according to some embodiments. The method may include receiving a first document having a first schema (602). The document and the first schema may be received as described above in FIGS. 1-2. For example, the first schema may define the format for service requests received by an incident management system, among other example operating environments.

The method may also include accessing a configuration for the first schema (604). The configuration may define how to generate, from the first document, a plurality of queries into a collection of documents having a second schema. The second schema may be the same as the first schema or different from the first schema. As described above in FIGS. 5A-5B, the schema may define field-value pairs in document formats, value types, field names, metadata, and/or other information related to the structure or format of the document. In specific examples, the configuration may include a query type defining an n-gram level (e.g., 1-gram, 3-gram, etc.) for some of the queries to be generated. Configuration may also include a number of queries to be generated for each query type, where the words or n-grams selected for the queries are based on a frequency score. The frequency score may represent a product of a number of times a word appears in a source field and an inverse of a number of documents in which the word appears in the document repository.

The method may further include generating the plurality of queries based on the configuration (606). The plurality of queries may be concatenated together using union or “OR” operators to form a single query that may be executed against the document repository. The document repository may include collections of documents having different schemas that are part of a knowledge base. The method may additionally include combining results of the plurality of queries into similarity scores for the first document (608). The results of each of the queries may be weighted according to the weights provided in the configuration. The individual scores for each target document may then be combined into a single similarity score for each document as a weighted combination, and the scores may be used to order or present result documents for the user or client device.

It should be appreciated that the specific steps illustrated in FIG. 6 provide particular methods of generating similarity scores according to various embodiments. Other sequences of steps may also be performed according to alternative embodiments. For example, alternative embodiments may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

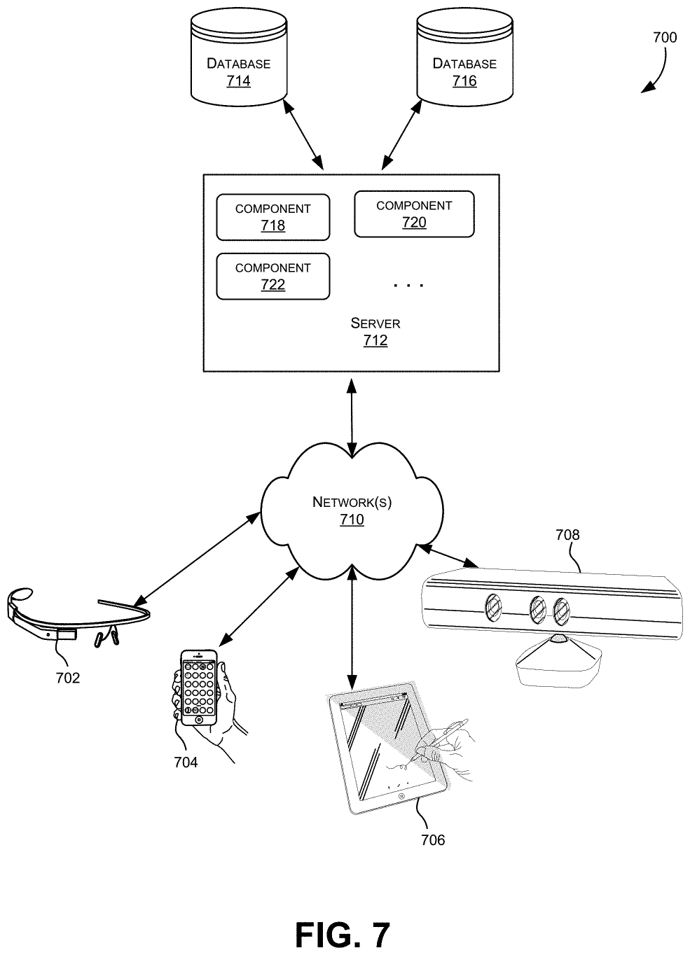

FIG. 7 depicts a simplified diagram of a distributed system 700 for implementing one of the embodiments. In the illustrated embodiment, distributed system 700 includes one or more client computing devices 702, 704, 706, and 708, which are configured to execute and operate a client application such as a web browser, proprietary client (e.g., Oracle Forms), or the like over one or more network(s) 710. Server 712 may be communicatively coupled with remote client computing devices 702, 704, 706, and 708 via network 710.

In various embodiments, server 712 may be adapted to run one or more services or software applications provided by one or more of the components of the system. In some embodiments, these services may be offered as web-based or cloud services or under a Software as a Service (SaaS) model to the users of client computing devices 702, 704, 706, and/or 708. Users operating client computing devices 702, 704, 706, and/or 708 may in turn utilize one or more client applications to interact with server 712 to utilize the services provided by these components.

In the configuration depicted in the figure, the software components 718, 720 and 722 of system 700 are shown as being implemented on server 712. In other embodiments, one or more of the components of system 700 and/or the services provided by these components may also be implemented by one or more of the client computing devices 702, 704, 706, and/or 708. Users operating the client computing devices may then utilize one or more client applications to use the services provided by these components. These components may be implemented in hardware, firmware, software, or combinations thereof. It should be appreciated that various different system configurations are possible, which may be different from distributed system 700. The embodiment shown in the figure is thus one example of a distributed system for implementing an embodiment system and is not intended to be limiting.

Client computing devices 702, 704, 706, and/or 708 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 702, 704, 706, and 708 may be any other electronic device, such as a thin-client computer, an Internet-enabled gaming system (e.g., a Microsoft Xbox gaming console with or without a Kinect® gesture input device), and/or a personal messaging device, capable of communicating over network(s) 710.

Although exemplary distributed system 700 is shown with four client computing devices, any number of client computing devices may be supported. Other devices, such as devices with sensors, etc., may interact with server 712.

Network(s) 710 in distributed system 700 may be any type of network that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 710 can be a local area network (LAN), such as one based on Ethernet, Token-Ring and/or the like. Network(s) 710 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 712 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 712 may be adapted to run one or more services or software applications described in the foregoing disclosure. For example, server 712 may correspond to a server for performing processing described above according to an embodiment of the present disclosure.

Server 712 may run an operating system including any of those discussed above, as well as any commercially available server operating system. Server 712 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 712 may include one or more applications to analyze and consolidate data feeds and/or event updates received from users of client computing devices 702, 704, 706, and 708. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 712 may also include one or more applications to display the data feeds and/or real-time events via one or more display devices of client computing devices 702, 704, 706, and 708.

Distributed system 700 may also include one or more databases 714 and 716. Databases 714 and 716 may reside in a variety of locations. By way of example, one or more of databases 714 and 716 may reside on a non-transitory storage medium local to (and/or resident in) server 712. Alternatively, databases 714 and 716 may be remote from server 712 and in communication with server 712 via a network-based or dedicated connection. In one set of embodiments, databases 714 and 716 may reside in a storage-area network (SAN). Similarly, any necessary files for performing the functions attributed to server 712 may be stored locally on server 712 and/or remotely, as appropriate. In one set of embodiments, databases 714 and 716 may include relational databases, such as databases provided by Oracle, that are adapted to store, update, and retrieve data in response to SQL-formatted commands.

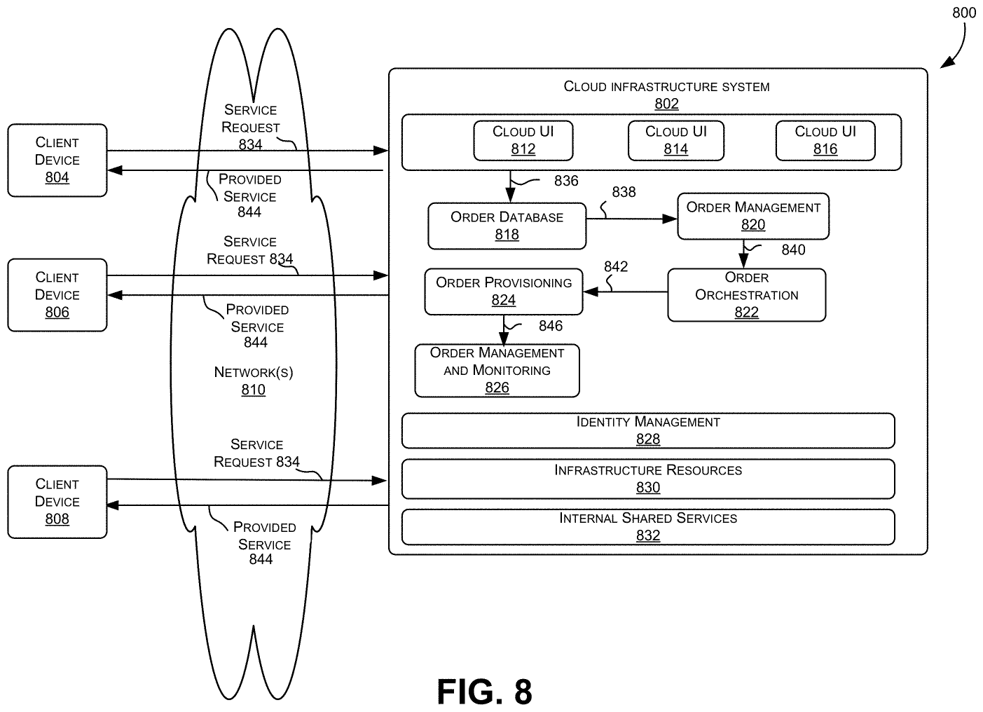

FIG. 8 is a simplified block diagram of one or more components of a system environment 800 by which services provided by one or more components of an embodiment system may be offered as cloud services, in accordance with an embodiment of the present disclosure. In the illustrated embodiment, system environment 800 includes one or more client computing devices 804, 806, and 808 that may be used by users to interact with a cloud infrastructure system 802 that provides cloud services. The client computing devices may be configured to operate a client application such as a web browser, a proprietary client application (e.g., Oracle Forms), or some other application, which may be used by a user of the client computing device to interact with cloud infrastructure system 802 to use services provided by cloud infrastructure system 802.

It should be appreciated that cloud infrastructure system 802 depicted in the figure may have other components than those depicted. Further, the system shown in the figure is only one example of a cloud infrastructure system that may incorporate some embodiments. In some other embodiments, cloud infrastructure system 802 may have more or fewer components than shown in the figure, may combine two or more components, or may have a different configuration or arrangement of components.

Client computing devices 804, 806, and 808 may be devices similar to those described above for 702, 704, 706, and 708.

Although exemplary system environment 800 is shown with three client computing devices, any number of client computing devices may be supported. Other devices such as devices with sensors, etc. may interact with cloud infrastructure system 802.

Network(s) 810 may facilitate communications and exchange of data between clients 804, 806, and 808 and cloud infrastructure system 802. Each network may be any type of network that can support data communications using any of a variety of commercially-available protocols, including those described above for network(s) 710.

Cloud infrastructure system 802 may comprise one or more computers and/or servers that may include those described above for server 712.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 802 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 802 may be adapted to automatically provision, manage and track a customer's subscription to services offered by cloud infrastructure system 802. Cloud infrastructure system 802 may provide the cloud services via different deployment models. For example, services may be provided under a public cloud model in which cloud infrastructure system 802 is owned by an organization selling cloud services (e.g., owned by Oracle) and the services are made available to the general public or different industry enterprises. As another example, services may be provided under a private cloud model in which cloud infrastructure system 802 is operated solely for a single organization and may provide services for one or more entities within the organization. The cloud services may also be provided under a community cloud model in which cloud infrastructure system 802 and the services provided by cloud infrastructure system 802 are shared by several organizations in a related community. The cloud services may also be provided under a hybrid cloud model, which is a combination of two or more different models.

In some embodiments, the services provided by cloud infrastructure system 802 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 802. Cloud infrastructure system 802 then performs processing to provide the services in the customer's subscription order.

In some embodiments, the services provided by cloud infrastructure system 802 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 802 may also include infrastructure resources 830 for providing the resources used to provide various services to customers of the cloud infrastructure system. In one embodiment, infrastructure resources 830 may include pre-integrated and optimized combinations of hardware, such as servers, storage, and networking resources to execute the services provided by the PaaS platform and the SaaS platform.

In some embodiments, resources in cloud infrastructure system 802 may be shared by multiple users and dynamically re-allocated per demand. Additionally, resources may be allocated to users in different time zones. For example, cloud infrastructure system 830 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 832 may be provided that are shared by different components or modules of cloud infrastructure system 802 and by the services provided by cloud infrastructure system 802. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 802 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 802, and the like.

In one embodiment, as depicted in the figure, cloud management functionality may be provided by one or more modules, such as an order management module 820, an order orchestration module 822, an order provisioning module 824, an order management and monitoring module 826, and an identity management module 828. These modules may include or be provided using one or more computers and/or servers, which may be general purpose computers, specialized server computers, server farms, server clusters, or any other appropriate arrangement and/or combination.

In exemplary operation 834, a customer using a client device, such as client device 804, 806 or 808, may interact with cloud infrastructure system 802 by requesting one or more services provided by cloud infrastructure system 802 and placing an order for a subscription for one or more services offered by cloud infrastructure system 802. In certain embodiments, the customer may access a cloud User Interface (UI), cloud UI 812, cloud UI 814 and/or cloud UI 816 and place a subscription order via these UIs. The order information received by cloud infrastructure system 802 in response to the customer placing an order may include information identifying the customer and one or more services offered by the cloud infrastructure system 802 that the customer intends to subscribe to.

After an order has been placed by the customer, the order information is received via the cloud UIs, 812, 814 and/or 816.

At operation 836, the order is stored in order database 818. Order database 818 can be one of several databases operated by cloud infrastructure system 818 and operated in conjunction with other system elements.

At operation 838, the order information is forwarded to an order management module 820. In some instances, order management module 820 may be configured to perform billing and accounting functions related to the order, such as verifying the order, and upon verification, booking the order.

At operation 840, information regarding the order is communicated to an order orchestration module 822. Order orchestration module 822 may utilize the order information to orchestrate the provisioning of services and resources for the order placed by the customer. In some instances, order orchestration module 822 may orchestrate the provisioning of resources to support the subscribed services using the services of order provisioning module 824.

In certain embodiments, order orchestration module 822 enables the management of business processes associated with each order and applies business logic to determine whether an order should proceed to provisioning. At operation 842, upon receiving an order for a new subscription, order orchestration module 822 sends a request to order provisioning module 824 to allocate resources and configure those resources needed to fulfill the subscription order. Order provisioning module 824 enables the allocation of resources for the services ordered by the customer. Order provisioning module 824 provides a level of abstraction between the cloud services provided by cloud infrastructure system 800 and the physical implementation layer that is used to provision the resources for providing the requested services. Order orchestration module 822 may thus be isolated from implementation details, such as whether or not services and resources are actually provisioned on the fly or pre-provisioned and only allocated/assigned upon request.

At operation 844, once the services and resources are provisioned, a notification of the provided service may be sent to customers on client devices 804, 806 and/or 808 by order provisioning module 824 of cloud infrastructure system 802.

At operation 846, the customer's subscription order may be managed and tracked by an order management and monitoring module 826. In some instances, order management and monitoring module 826 may be configured to collect usage statistics for the services in the subscription order, such as the amount of storage used, the amount data transferred, the number of users, and the amount of system up time and system down time.

In certain embodiments, cloud infrastructure system 800 may include an identity management module 828. Identity management module 828 may be configured to provide identity services, such as access management and authorization services in cloud infrastructure system 800. In some embodiments, identity management module 828 may control information about customers who wish to utilize the services provided by cloud infrastructure system 802. Such information can include information that authenticates the identities of such customers and information that describes which actions those customers are authorized to perform relative to various system resources (e.g., files, directories, applications, communication ports, memory segments, etc.) Identity management module 828 may also include the management of descriptive information about each customer and about how and by whom that descriptive information can be accessed and modified.

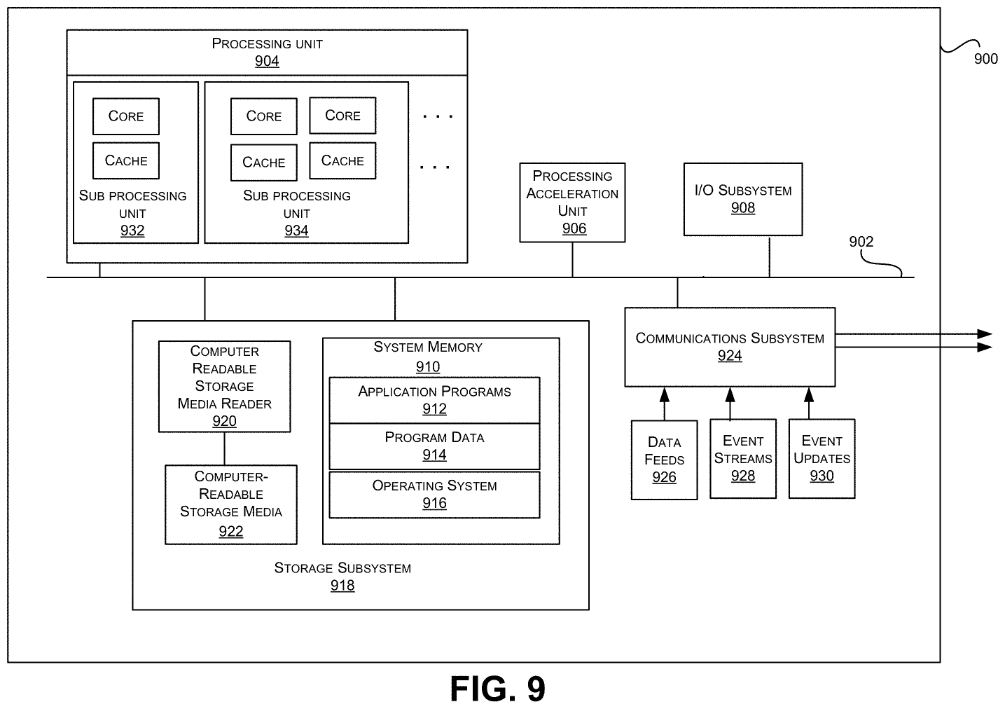

FIG. 9 illustrates an exemplary computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA

(EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with some embodiments.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A non-transitory computer-readable medium comprising instructions that, when executed by one or more processors, cause the one or more processors to perform operations comprising:
receiving a first document having a first schema;
accessing a configuration for the first schema, wherein the configuration defines how to generate, from the first document, a plurality of queries into a collection of documents having a second schema;
generating the plurality of a queries based on the configuration; and
combining results of the plurality of queries into similarity scores for the first document.

2. The non-transitory computer-readable medium of claim 1, wherein the first schema is different from the second schema.

3. The non-transitory computer-readable medium of claim 1, wherein the first schema defines service requests, the collection of documents is part of a knowledge base, and the second schema defines text documents comprising solutions for the service requests.

4. The non-transitory computer-readable medium of claim 1, wherein the configuration defines how to generate, from the first document, queries into a plurality of collections of documents having a plurality of different schemas.

5. The non-transitory computer-readable medium of claim 1, wherein the plurality of queries are submitted to a search interface that comprises an inverted index that accepts Boolean and phrase queries, and an Application Programming Interface (API) that receives a word and returns a number of documents in the collection of documents in which that word is used.

6. The non-transitory computer-readable medium of claim 1, wherein the first schema defines a plurality of field-value pairs.

7. The non-transitory computer-readable medium of claim 1, wherein the configuration comprises, for a first field in the first document, a query type defining an n-gram level for a first subset of the plurality of queries.

8. The non-transitory computer-readable medium of claim 7, wherein the configuration further comprises, for the query type, a number of queries N to be generated for the query type.

9. The non-transitory computer-readable medium of claim 8, wherein generating the number of queries N for the query type comprises:
determining a frequency score from the collection of documents for words in the first field;
identifying the words in the first field having the N highest frequency scores; and
generating N queries from the words in the first field having the N highest frequency scores.

10. The non-transitory computer-readable medium of claim 9, wherein the frequency score is determined based on a number of times a word appears in the first document and a number of documents in the collection of documents in which the word appears.

11. The non-transitory computer-readable medium of claim 7, wherein the configuration further comprises, for the query type, one or more target fields in the second schema.

12. The non-transitory computer-readable medium of claim 11, wherein the configuration further comprises, for a first target field in the one or more target fields, a weight to be applied to similarity scores for queries generated from the first target field.

13. The non-transitory computer-readable medium of claim 12, wherein the weight is set in the configuration by a machine-learning model.

14. The non-transitory computer-readable medium of claim 1, wherein the configuration is one of a plurality of configurations, and the plurality of configurations correspond to a plurality of different schemas.

15. The non-transitory computer-readable medium of claim 1, wherein the first document is received as part of a search request to identify documents in the collection of documents that are similar to the first document.

16. The non-transitory computer-readable medium of claim 1, wherein the operations further comprise executing the plurality of queries on the collection of documents.

17. The non-transitory computer-readable medium of claim 16, wherein the results of the plurality of queries comprise scores for a second document in the collection of documents, and the scores for the second document are generated in response to the plurality of queries.

18. The non-transitory computer-readable medium of claim 17, wherein the combining the results of the plurality of queries into similarity scores comprises generating a weighted combination of scores for the second document.

19. A system comprising:
one or more processors; and
one or more memory devices comprising instructions that, when executed by the one or more processors, cause the one or more processors to perform operations comprising:
receiving a first document having a first schema;
accessing a configuration for the first schema, wherein the configuration defines how to generate, from the first document, a plurality of queries into a collection of documents having a second schema;
generating the plurality of a queries based on the configuration; and
combining results of the plurality of queries into similarity scores for the first document.

20. A method of calculating similarity scores for documents, the method comprising:
receiving a first document having a first schema;
accessing a configuration for the first schema, wherein the configuration defines how to generate, from the first document, a plurality of queries into a collection of documents having a second schema;
generating the plurality of a queries based on the configuration; and
combining results of the plurality of queries into similarity scores for the first document.
